(19) United States
(12) Patent Application Publication
(10) Pub. No.: US 2013/0255242 A1
(43) Pub. Date: Oct. 3, 2013

(54) IMPELLER WITH ASSOCIATED WEAR MEMBER

(71) Applicant: Jason R. WALKER, Pekin, IL (US)

(72) Inventor: Jason R. WALKER, Pekin, IL (US)

(73) Assignee: Caterpillar Inc.

(21) Appl. No.: 13/435,602

(22) Filed: Mar. 30, 2012

(51) Int. Cl. F16D 33/18; B22D 25/02

(52) U.S. Cl. 60/364; 164/69.1

(57) ABSTRACT

An impeller for a torque converter includes a rotating housing portion, a blade portion configured to create fluid flow for pumping fluid to a turbine of the torque converter, and an impeller hub portion configured to couple the impeller to the torque converter and rotate about an output shaft of the torque converter. The impeller hub portion defines an inner surface having an annular recess, and at least one inlet passage and at least one outlet passage to provide flow paths for fluid entering and exiting the impeller. The torque converter further includes a wear member at least partially received in the annular recess, the annular wear member being formed from a ferrous material. The rotating housing portion, the blade portion, and the impeller hub portion are integrally formed as a single piece casting.

### TECHNICAL FIELD

The present disclosure relates to an impeller for a torque converter and, more particularly, to an impeller and an associated wear member.

### BACKGROUND

It is often desirable to provide a coupling between the rotating output of a prime mover and the rotating input of a driven load that permits a disparity between the rotational speed of the rotating output of the prime mover and the rotating input of the driven load. For example, in order to permit continuous rotation of the output of the prime mover, even when it is desirable to stop rotation of the input of the driven load, it is desirable to provide a coupling that permits the rotational output of the prime mover to continue despite the input of the driven load being stopped.

An example of such a coupling is a torque converter, which provides a hydrodynamic fluid coupling between the rotating output of a prime mover and the rotating input of a driven load. For example, a machine such as a vehicle may include an internal combustion engine and a transmission, with the output of the internal combustion engine coupled to an input of the transmission by the torque converter.

A torque converter generally includes an input coupling for coupling the output of a prime mover to the input of the torque converter, and an output shaft for coupling the output of the torque converter to a driven load, such as a transmission. The torque converter further includes a housing containing fluid, such as hydraulic fluid. Within the housing, the input coupling is coupled to a pump including an impeller for pumping the fluid in the housing. The torque converter further includes a turbine coupled to the output shaft of the torque converter. The impeller of the pump, driven by the input coupling, pumps fluid through the turbine, thereby causing the turbine to rotate and drive the output shaft of the torque converter and the input of, for example, a transmission. By virtue of the fluid coupling provided by the interaction between the impeller and the turbine, the output of the prime mover may continue to rotate the input coupling of the torque converter, even when the output shaft of the torque converter is stopped.

In conventional torque converters, as a result of various factors, the impeller is an assembly of several parts, including, for example, a rotating housing, an impeller member including blades configured to pump fluid, and a hub member. Rather than being formed as a single piece, these parts are typically secured to one another by fasteners, adhesives, and/or welding. The use of separate parts results from differing requirements associated with the parts and manufacturing limitations. For example, the blades may be formed separately and attached to the impeller member to provide an ability to form blades having complex configurations. The hub member may be formed from relatively stronger materials than the remainder of the impeller in order to account for higher stress and/or wear associated with the hub member during operation of the torque converter. In addition, it may be difficult to form the entire impeller using relatively less expensive processes such as casting due to the relatively complex shape of the parts. As a result, it may be relatively costly to manufacture and assemble the impeller. Maintenance costs associated with the torque converter may also increase due to these limitations. As a result of potential drawbacks such as those mentioned above, it may be desirable to provide an impeller for a torque converter that is less costly to manufacture and maintain, but which still provides desired operation and service life characteristics.

An example of torque converter parts formed via casting is described in U.S. Patent Application No. US 2004/0062650 to Makim et al. (“the '650 application”). In particular, the '650 application discloses an assembly for a fluid coupling that includes a hub having a body portion defining a central bore therethrough, with a radially extending flange extending from the body portion. The hub is formed of a material that has a higher melting temperature than aluminum, and a wheel having an outer shell portion is cast about the radially extending flange. The wheel has an integrally cast set of blades, with the outer shell and blades made of aluminum.

Although the assembly disclosed in the '650 application may provide some advantages relative to some conventional assemblies, it may suffer from a number of possible drawbacks. For example, due to the multiple casting processes required for manufacturing the assembly, it may be undesirably costly and complicated to produce. Further, due to the different materials included in the assembly, potential problems associated with securing the parts of the assembly together may result in a relative lack of durability. The torque converter and method disclosed herein may be directed to mitigating or overcoming these and other possible drawbacks.

### SUMMARY

In one aspect, the present disclosure includes an impeller for a torque converter. The impeller includes a rotating housing portion configured to be driven by a prime mover, a blade portion including a plurality of blades configured to create fluid flow for pumping fluid to a turbine of the torque converter, and an impeller hub portion configured to couple the impeller to the torque converter and rotate about an output shaft of the torque converter. The impeller hub portion defines an inner surface having an annular recess, and at least one inlet passage and at least one outlet passage configured to provide flow paths for fluid entering and exiting the impeller. The torque converter further includes an annular wear member at least partially received in the annular recess of the impeller hub portion, wherein the annular wear member is formed from a ferrous material. The rotating housing portion, the blade portion, and the impeller hub portion are integrally formed as a single piece casting.

In another aspect, the present disclosure includes a torque converter including an impeller configured to be rotated by a prime mover and pump fluid, a turbine configured to rotate as a result of fluid pumped by the impeller, and an output shaft coupled to the turbine and configured to be rotated by the turbine. The impeller includes a rotating housing portion configured to be driven by the prime mover, a blade portion including a plurality of blades configured to create fluid flow for pumping fluid to the turbine, and an impeller hub portion coupling the impeller to the torque converter such that the impeller rotates about the output shaft. The impeller hub portion defines an inner surface having an annular recess, and at least one inlet passage and at least one outlet passage configured to provide flow paths for fluid entering and exiting the impeller. The torque converter further includes an annular wear member at least partially received in the annular recess of the impeller hub portion. The annular wear member is formed from a ferrous material, and the rotating housing portion, the blade portion, and the impeller hub portion are integrally formed as a single piece casting.

In still a further aspect, the present disclosure includes a method for producing an impeller for a torque converter. The method includes casting as a single piece, an impeller for the torque converter. The impeller includes a rotating housing portion configured to be driven by a prime mover, a blade portion including a plurality of blades configured to create fluid flow for pumping fluid to a turbine of the torque converter, and an impeller hub portion configured to couple the impeller to the torque converter and rotate about an output shaft of the torque converter, wherein the impeller hub portion defines an inner surface having an annular recess. The method further includes boring at least one inlet passage in the impeller hub portion and boring at least one outlet passage in the impeller hub portion. Casting the impeller includes forming the impeller onto an annular wear member formed of a ferrous material, such that the annular wear member is retained by the annular recess of the impeller hub portion.

### BRIEF DESCRIPTION OF THE DRAWINGS

FIG. 1 is a partial section view of an exemplary embodiment of a torque converter.

FIG. 2 is a partial perspective section view of a portion of the exemplary embodiment shown in FIG. 1.

FIG. 3 is a partial section view of a portion of the exemplary embodiment shown in FIG. 1.

FIG. 4 is a partial section view of a portion of the exemplary embodiment shown in FIG. 3.

### DETAILED DESCRIPTION

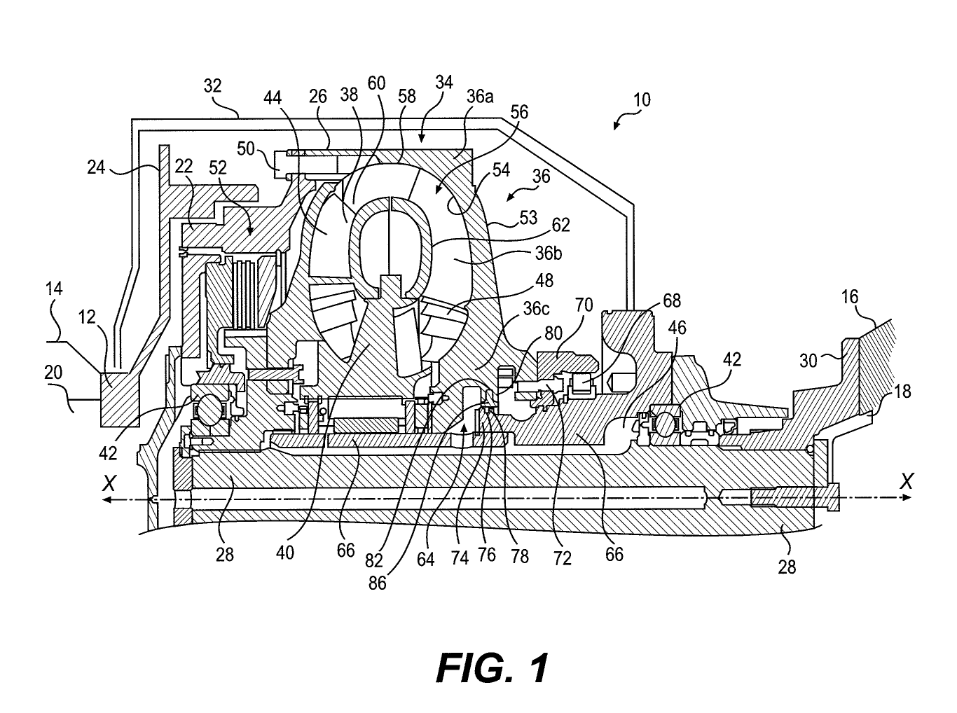

FIG. 1 is a partial section view of an exemplary embodiment of a torque converter 10 configured to couple an output 12 of a prime mover 14 to an input member 16 of a driven mechanism 18. For example, prime mover 14 may be an internal combustion engine or an electric motor having an output shaft 20 configured to be coupled to an input coupling 22 of exemplary torque converter 10. As shown in FIG. 1, for example, output shaft 20 is coupled to a flywheel 24, which, in turn, is coupled to a rotating housing 26 of exemplary torque converter 10. In the exemplary embodiment shown, flywheel 24, driven by prime mover 14, is coupled to and drives rotating housing 26. Exemplary torque converter 10 includes an output shaft 28 coupled to input member 16 of driven mechanism 18 via an output yoke 30. Driven mechanism 18 may be an input of a machine such as, for example, a transmission of a machine such as a vehicle, pump, compressor, or generator, or any other machine configured to be driven by a prime mover.

In the exemplary embodiment shown in FIG. 1, torque converter 10 includes a housing 32 configured to house the moving parts of torque converter 10, as well as fluid used to provide a fluid coupling between input member 16 and output shaft 28 of torque converter 10. Housing 32 contains rotating housing 26, which is coupled to a pump 34 having an impeller 36 configured to pump fluid within rotating housing 26. Torque converter 10 further includes a turbine 38 opposite impeller 36. Turbine 38 is coupled to output shaft 28, for example, via a splined coupling, such that as turbine 38 rotates, output shaft 28 also rotates. Exemplary torque converter 10 shown in FIG. 1 further includes a stator 40 configured to re-direct fluid exiting turbine 38 back to impeller 36 of pump 34 to improve efficiency. Output shaft 28 rotates about longitudinal axis X on a pair of bearings 42 located at opposite ends of output shaft 28, with bearings 42 being mounted in a fixed manner relative to housing 32 of torque converter 10.

During operation, prime mover 14 rotates flywheel 24, which is coupled to rotating housing 26 of torque converter 10, thereby driving rotating housing 26. Impeller 36 of pump 34, being coupled to rotating housing 26, rotates about output shaft 28 and pumps fluid through turbine 38. Turbine 38 includes a plurality of vanes 44 configured to rotate turbine 38 about longitudinal axis X as fluid flows through vanes 44. Turbine 38, by virtue of being coupled to output shaft 28 of torque converter 10, drives output shaft 28, which is coupled to driven mechanism 18 by output yoke 30. Thus, the interaction of the fluid being pumped through turbine 38 by impeller 36 provides a hydrodynamic fluid coupling between prime mover 14 and driven mechanism 18.

The hydrodynamic fluid coupling permits output 12 of prime mover 14 to rotate at a different speed than input member 16 of driven mechanism 18. For example, for machines such as vehicles, prime mover 14 may operate at a relatively low speed while input member 16 of the transmission is held in a stopped condition (e.g., by operation of brakes of the vehicle). Pump 34 of torque converter 10 pumps fluid through turbine 38, but by holding input member 16 in a stopped condition, the energy of the pumped fluid can be absorbed by heating of the fluid rather than turning turbine 38. However, if input member is no longer held in a stopped condition, fluid pumped through turbine 38 causes it to rotate, thereby rotating output shaft 28 of torque converter 10. As the speed of output 12 of prime mover 14 is increased, pump 34 of torque converter 10 pumps fluid through turbine 38 at an increasing rate, thereby causing turbine 38 and output shaft 28 to rotate at an increasing rate.

In the exemplary embodiment shown, output shaft 28 rotates about longitudinal axis X on bearings 42. Housing 32 includes a lubricating passage 46 configured to supply the bearing 42 located at the end of output shaft 28 adjacent output yoke 30 of torque converter 10. Lubricant may be provided under pressure to ensure sufficient lubrication and cooling of bearing 42. For example, lubricant may be supplied to bearing 42 at about 70 pounds per square inch (psi).

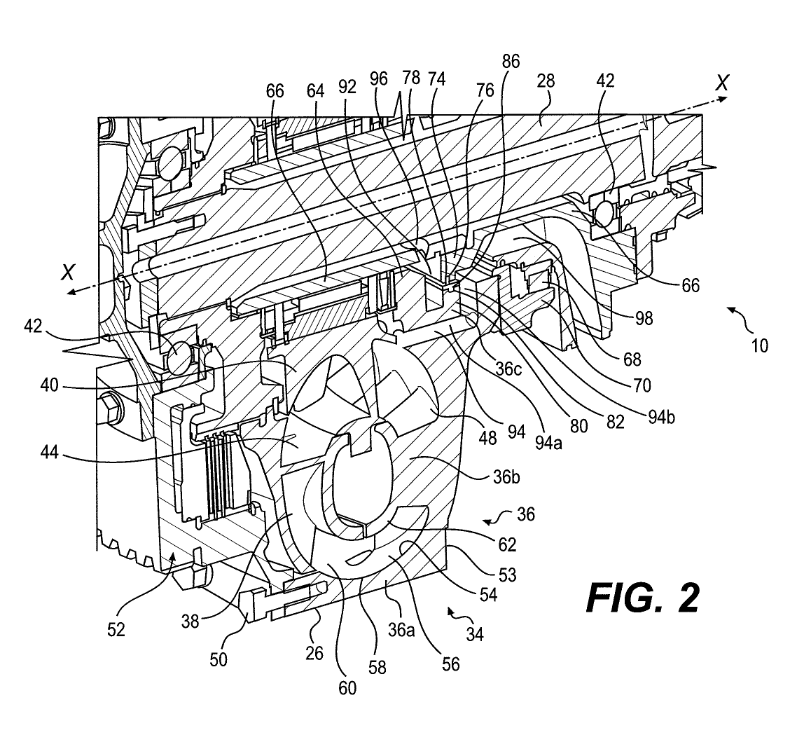

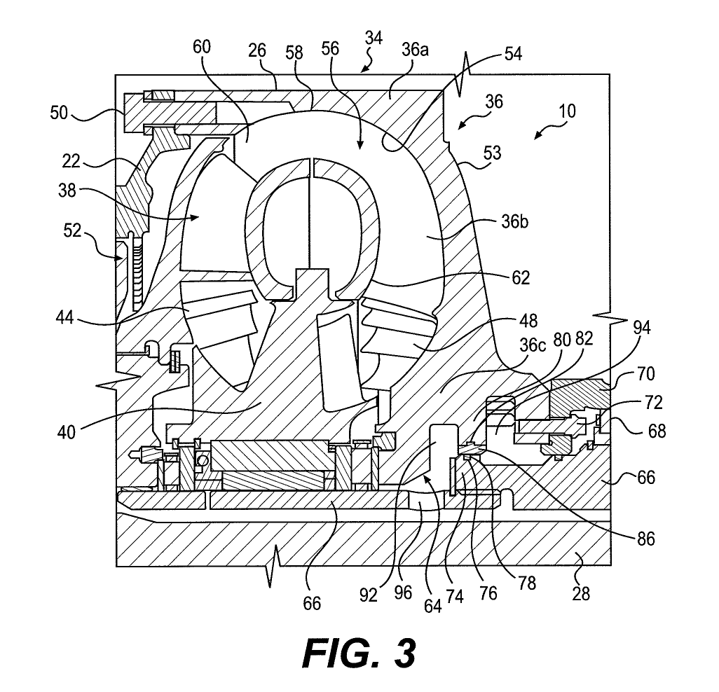

As shown in FIGS. 2 and 3, exemplary impeller 36 defines a rotating housing portion 36a, a blade portion 36b including a plurality of blades 48 configured to pump fluid, and an impeller hub portion 36c configured to couple impeller 36 to torque converter 10, such that impeller 36 rotates about output shaft 28. According to the exemplary embodiment shown, rotating housing portion 36a, blade portion 36b, and an impeller hub portion 36c are integrally formed as a single piece casting (e.g., in a single casting process). According to some embodiments, the single piece casting is formed from aluminum or alloys thereof, although other suitable materials known to those skilled in the art are contemplated.

As shown in FIGS. 2 and 3, rotating housing portion 36a is coupled to input coupling 22 via fasteners 50 (e.g., such as bolts). In the exemplary embodiment shown, input coupling serves as a housing of lock-up clutch assembly 52. By virtue of input coupling 22 being coupled to flywheel 24 of prime mover 14, input coupling 22 drives rotating housing portion 36a.

In the exemplary embodiment shown, rotating housing portion 36a defines an outer surface 53 and an inner surface 54. Inner surface 54 defines a curved annular cavity 56, which curves through an apex 58 relative to longitudinal axis X, and around toward a portion of turbine 38, such that an end 60 of inner surface 54 it closer to longitudinal axis X than apex 58. As impeller 36 rotates, fluid flows in cavity 56 from a portion of cavity 56 closer to impeller hub portion 36c toward apex 58 and into turbine 38.

Blade portion 36b of exemplary impeller 36 is within rotating housing portion 36a, with blade portion 36b including an inner wall 62. Blades 48 extend from inner surface 54 of rotating housing portion 36a to inner wall 62.

Impeller hub portion 36c of exemplary impeller 36 defines an inner surface 64 extending around a sleeve 66 supporting stator 40. Sleeve 66 does not rotate, and impeller 36 rotates about sleeve 66 on bearing 42 associated with lock-up clutch assembly 52 and bearing 68 (e.g., a roller bearing) between sleeve 66 and a coupling member 70 (e.g., a gear) to which a longitudinal end of impeller hub portion 36c is coupled via one or more fasteners 72 (e.g., such as one or more bolts) (see FIGS. 1 and 3).

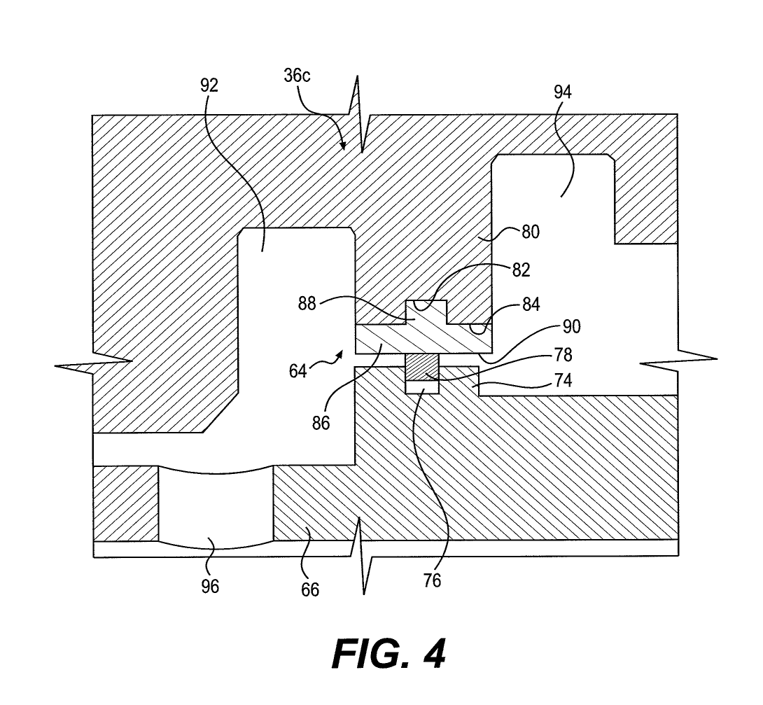

As shown in FIGS. 2 and 3, exemplary sleeve 66 includes an outwardly extending annular flange 74, which includes a recess 76 in which a seal member 78 is received. Seal member 78 may be formed of elastomeric material or any other seal material known to those skilled in the art. Impeller hub portion 36c includes an inwardly extending annular projection 80 configured to correspond longitudinally to flange 74 of sleeve 66. As shown in FIG. 4, annular projection 80 defines an annular recess 82 and a face portion 84. An annular wear member 86 is partially received in annular recess 82 of projection 80, thereby forming an end of projection 80, for example, covering face portion 84. In the exemplary embodiment shown, wear member 86 defines a ridge 88 for receipt in annular recess 82, and an end face 90 configured to abut against seal member 78 of sleeve 66 during operation of torque converter 10 to provide a fluid seal.

According to some embodiments, annular wear member 86 (or end face 90 thereof) may be formed from a relatively hard material configured to exhibit reduced wear caused by sliding motion of seal member 78 against end face 90. For example, wear member 86, or end face 90, may be formed from a ferrous material, such as, for example, steel or cast iron, or any other suitable material known to those skilled in the art.

According to some embodiments, impeller 36 is formed by casting rotating housing portion 36a, blade portion 36b, and impeller hub portion 36c onto wear member 86, for example, such that wear member 86 may be retained in annular recess 82 of impeller hub portion 36c without adhesives, welding, or fasteners. For example, wear member 86 may be formed prior to casting impeller 36, and wear member 86 may be placed in a casting mold used for forming impeller 36 prior to supplying the molten casting material into the mold. Thereafter, the molten casting material may be poured into the mold, and after the molten casting material cools, wear member 86 is retained in annular recess 82. According to some embodiments, annular recess 82 and/or wear member 86 may be configured to enhance the retention of wear member 86 in annular recess 82, for example, by provision of protrusions, grooves, etc., on ridge 88 of wear member 86 for improving engagement between ridge 88 and annular recess 82.

According to some embodiments, the casting material used to form impeller 36 may include aluminum and alloys thereof, and wear member 86 may be formed from a ferrous material such as steel or cast iron. By virtue of wear member 86 being steel or cast iron, which typically has a higher melting temperature than aluminum, and the casting material being aluminum, the material of wear member 86 will not be significantly softened or melt when the molten aluminum is poured into the casting mold.

As shown FIGS. 2 and 3, exemplary impeller 36 includes one or more inlet passages 92 and one or more outlet passages 94 in impeller hub portion 36c. For example, sleeve 66 includes one more radially extending sleeve inlet passages 96 that are longitudinally aligned with inlet passage(s) 92 of impeller hub portion 36c. Sleeve inlet passage(s) 96 is/are configured to supply fluid to inlet passage(s) 92, which extend radially and substantially perpendicular with respect to output shaft 28, and provide flow communication with blade portion 36b of impeller 36. Exemplary sleeve 66 also includes one or more sleeve outlet passages 98, and exemplary outlet passage(s) 94 of impeller hub portion 36c include(s) a first portion 94a that extends in a direction substantially parallel to output shaft 28, and a second portion 94b that extends radially toward output shaft 28 in a direction substantially perpendicular to output shaft 28 (see FIG. 2). The end of second portion 94b is in flow communication with sleeve outlet passage 98, such that fluid exiting impeller 36 and/or turbine 38 is in flow communication with a fluid circuit of torque converter 10. Fluid may circulate in fluid circuit by entering impeller 36 at inlet passage(s) 92 of impeller hub portion 36c via sleeve inlet passage(s) 96, and by being pump by blade portion 36b through turbine 38 and out outlet passages(s) 94 of impeller hub portion 36c. Thereafter, the fluid may circulate through other portions of torque converter 10, which may serve to cool the fluid before it returns to impeller 36.

According to some embodiments, inlet passage(s) 92 and/or outlet passage(s) 94 of impeller hub portion 36c may be formed by boring passages into impeller hub portion 36c. For example, after impeller 36 is cast, inlet passage(s) 92 may be bored into impeller hub portion 36c by boring a passage or passages from an inner diameter of impeller hub portion 36c in a radial direction toward blade portion 36b. Outlet passage(s) 94 may be bored into impeller hub portion 36c by boring a passage or passages from an inner diameter of impeller hub portion 36c in a radial direction toward blade portion 36b, and boring a passage or passages from blade portion 36b in a longitudinal direction toward the passage(s) bored in the radial direction until the two bored passages meet to form first portion 94a and second portion 94b of outlet passages 94.

### INDUSTRIAL APPLICABILITY

According to some embodiments, torque converter 10 may result in improved performance and reduced materials and manufacturing costs. For example, by virtue of the parts of exemplary impeller 36 being formed of a relatively lightweight material, such as aluminum, impeller 36 may provide improved performance resulting from reduced weight and inertia. This may result in more efficient operation of prime mover 14 coupled to torque converter 10 and quicker response by impeller 36. In addition, exemplary wear member 86 provides impeller 36 with improved durability. Because impeller 36 is formed from a lightweight material such as aluminum, such lightweight materials may not be able to withstand heat and wear associated with a seal member sliding against the lightweight material. By virtue of wear member 86 being formed from a material resistant to wear, excessive wear may be avoided, even though impeller 36 may be formed from a less durable material.

Exemplary torque converter 10 may also provide reduced material and manufacturing costs. For example, by forming impeller 36 from a relatively less expensive material such as aluminum, impeller 36 may be relatively less expensive to manufacture. In addition, because impeller 36 is cast as a single piece, the number of parts for assembly of torque converter 10 may be greatly reduced, thereby resulting in reduced assembly and labor costs.

It will be apparent to those skilled in the art that various modifications and variations can be made to the exemplary disclosed systems and methods. Other embodiments will be apparent to those skilled in the art from consideration of the specification and practice of the exemplary disclosed embodiments. It is intended that the specification and examples be considered as exemplary only, with a true scope being indicated by the following claims and their equivalents.

What is claimed is:

1. An impeller for a torque converter, the impeller comprising:
a rotating housing portion configured to be driven by a prime mover;
a blade portion including a plurality of blades configured to create fluid flow for pumping fluid to a turbine of the torque converter;
an impeller hub portion configured to couple the impeller to the torque converter and rotate about an output shaft of the torque converter, wherein the impeller hub portion defines:
an inner surface having an annular recess; and
at least one inlet passage and at least one outlet passage configured to provide flow paths for fluid entering and exiting the impeller; and
an annular wear member at least partially received in the annular recess of the impeller hub portion, the annular wear member being formed from a ferrous material,
wherein the rotating housing portion, the blade portion, and the impeller hub portion are integrally formed as a single piece casting.

2. The impeller of claim 1, wherein the single piece casting is formed from aluminum.

3. The impeller of claim 1, wherein the annular wear member is formed from cast iron.

4. The impeller of claim 1, wherein the single piece casting is formed onto the annular wear member, such that the annular wear member is retained by the annular recess of the impeller hub portion without adhesives, welding, or fasteners.

5. The impeller of claim 1, wherein the annular wear member is configured to ride against a seal member during operation of the torque converter.

6. The impeller of claim 1, wherein the inner surface of the impeller hub portion is formed by an annular projection, wherein the annular recess is defined by an end of the annular projection, and the annular wear member is on the end of the annular projection.

7. The impeller of claim 1, wherein at least a portion of the at least one inlet passage is substantially perpendicular to the output shaft of the torque converter and provides fluid communication with the blade portion of the impeller.

8. The impeller of claim 1, wherein at least a portion of the at least one outlet passage is substantially parallel to the output shaft of the torque converter and provides a flow path for fluid exiting the impeller.

9. The impeller of claim 1, wherein the at least one outlet passage includes a first portion extending substantially parallel to the output shaft and a second portion extending substantially perpendicular to the output shaft.

10. A torque converter comprising:
an impeller configured to be rotated by a prime mover and pump fluid;
a turbine configured to rotate as a result of fluid pumped by the impeller;
an output shaft coupled to the turbine and configured to be rotated by the turbine,
wherein the impeller includes:
a rotating housing portion configured to be driven by the prime mover;
a blade portion including a plurality of blades configured to create fluid flow for pumping fluid to the turbine;
an impeller hub portion coupling the impeller to the torque converter such that the impeller rotates about the output shaft, wherein the impeller hub portion defines:
an inner surface having an annular recess; and
at least one inlet passage and at least one outlet passage configured to provide flow paths for fluid entering and exiting the impeller; and
an annular wear member at least partially received in the annular recess of the impeller hub portion, the annular wear member being formed from a ferrous material,
wherein the rotating housing portion, the blade portion, and the impeller hub portion are integrally formed as a single piece casting.

11. The torque converter of claim 10, wherein the single piece casting is formed from aluminum.

12. The torque converter of claim 10, wherein the annular wear member is formed from cast iron.

13. The torque converter of claim 10, wherein the single piece casting is formed onto the annular wear member, such that the annular wear member is retained by the annular recess of the impeller hub portion without adhesives, welding, or fasteners.

14. The torque converter of claim 10, further including a sleeve between the inner surface of the impeller and the output shaft, wherein the sleeve includes an outer annular seal member, and the annular wear member provides a fluid seal with the annular seal member during operation of the torque converter.

15. The torque converter of claim 10, wherein the inner surface diameter of the impeller hub portion is formed by an annular projection, wherein the annular recess is defined by an end of the annular projection, and the annular wear member is on the end of the annular projection.

16. The torque converter of claim 10, further including a sleeve between the inner surface of the impeller and the output shaft, wherein the sleeve defines at least one radially extending passage, and wherein the at least one inlet passage of the impeller hub portion provides flow communication between the at least one radially extending passage and the blade portion of the impeller.

17. The torque converter of claim 10, wherein at least a portion of the at least one outlet passage is substantially parallel to the output shaft of the torque converter and provides flow communication for fluid exiting the impeller.

18. A method for producing an impeller for a torque converter, the method comprising:
casting as a single piece, an impeller for the torque converter, the impeller including:
a rotating housing portion configured to be driven by a prime mover;
a blade portion including a plurality of blades configured to create fluid flow for pumping fluid to a turbine of the torque converter;
an impeller hub portion configured to couple the impeller to the torque converter and rotate about an output shaft of the torque converter, wherein the impeller hub portion defines an inner surface having an annular recess;
boring at least one inlet passage in the impeller hub portion; and
boring at least one outlet passage in the impeller hub portion,
wherein casting the impeller includes forming the impeller onto an annular wear member formed of a ferrous material, such that the annular wear member is retained by the annular recess of the impeller hub portion.

19. The method of claim 18, wherein casting the impeller includes casting the impeller from aluminum.

20. The method of claim 18, wherein forming the impeller onto an annular wear member includes forming the impeller onto the annular wear member such that the annular wear member is retained by the annular recess of the impeller hub portion without adhesives, welding, or fasteners.
